(19) United States
(12) Patent Application Publication
(10) Pub. No.: US 2009/0024430 A1
(43) Pub. Date: Jan. 22, 2009

(54) METHOD FOR OPTIMIZING ROUTES FOR VEHICLE PARKING ENFORCEMENT

(76) Inventor: Cooper Marcus, San Francisco, CA (US)

Correspondence Address: SCHOX PLC, 730 Florida Street #2, San Francisco, CA, 94110, US

(21) Appl. No.: 12/171,564

(22) Filed: Jul. 11, 2008

Related U.S. Application Data
(60) Provisional application No. 60/949,488, filed on Jul. 12, 2007.

(51) Int. Cl. G01C 21/32; G06Q 10/00; G01C 21/20

(52) U.S. Cl. 705/7; 701/210; 701/200

(57) ABSTRACT

A method for optimizing routes for vehicle parking enforcement includes collecting input variable data, optimizing a parking enforcement route based on the input variable data, and communicating the optimized parking enforcement route to an enforcement agent.

### CROSS-REFERENCE TO RELATED APPLICATIONS

This application claims the benefit of U.S. Provisional Application No. 60/949,488 filed 12 Jul. 2007, which is incorporated in its entirety by this reference.

### TECHNICAL FIELD

This invention relates generally to the vehicle parking management field, and more specifically to a new and useful method for optimizing routes for vehicle parking enforcement in the vehicle parking management field.

### BACKGROUND

There are many factors that a parking enforcement agent must consider when they are enforcing parking. Even with an automated parking system notifying the enforcement agent of new events that require enforcement actions, the parking enforcement agent must make decisions about the route of their enforcement. Automated parking systems that include dynamic pricing and/or dynamic authorization rule sets further increase the number of possible parking enforcement situations to a level where even highly experienced parking enforcement agents will make decisions that result in non-optimal enforcement routes.

Thus, there is a need in the vehicle parking management field to create an improved system and method for optimizing routes for vehicle parking enforcement. This invention provides such improved system and method.

### BRIEF DESCRIPTION OF THE FIGURES

FIG. 1 is a flowchart representation of a preferred embodiment of the invention.

FIG. 2 is an example of an electronic mapping interface displaying the optimized route for a parking enforcement agent.

### DESCRIPTION OF THE PREFERRED EMBODIMENTS

The following description of the preferred embodiments of the invention is not intended to limit the invention to these preferred embodiments, but rather to enable any person skilled in the art of vehicle parking management to make and use this invention.

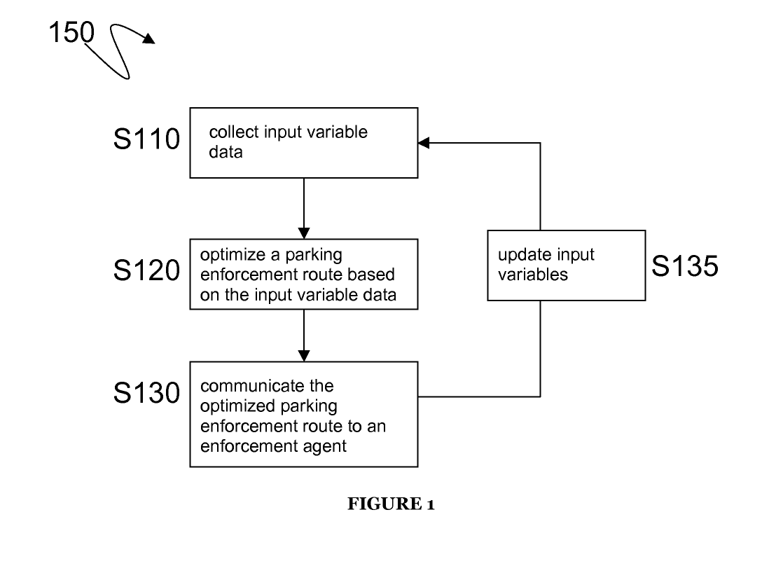

As shown in FIG. 1, a method 150 for optimizing routes for vehicle parking enforcement includes collecting input variable data Silo, optimizing a parking enforcement route based on the input variable data S120, and communicating the optimized parking enforcement route to an enforcement agent S130.

Step S110, which recites of collecting input variable data, functions to collect the required information for the route optimization. The input variable data preferably includes any variable or data that a parking enforcement agent would consider when planning their enforcement route, such as the type of vehicle and occupancy status, enforcement notifications (i.e. expired parking meters, illegal parking), clusters of parking violators, severity or price of a violation (such as a handicapped or fire hydrant violation), proximity of enforcer to violator, time to reach violator, time to create citation, time (such as time of day, date, day of the week, month of the year, season, year), special events (such as sporting events or theater), number of enforcement agents working concurrently, the parking grace period allowed by the lot, strictness of the enforcement or any other input considerations.

In one variation, the input variable data also includes predictions of likely violations based on historical data of the individual parker (recognized by assigned space, license plate, credit card/account number/payment id/RFID tag, make and model of the vehicle, or any other suitable identification) or historical data of the parking space itself. The prediction of parking violations is preferably based on an analysis of the historical parking data for the monitored parking area. If the occupant of the monitored area is known, the history of the monitored area occupant may be used independently or in collaboration with the monitored parking area historical data, to calculate a probability and likelihood of the monitored parking area occupant becoming a violator. The probability that a monitored area occupant becomes a violator is preferably calculated as a ratio of total violations of the occupant to total parking transactions of the occupant, but the probability calculation may be performed with any suitable ratio or statistical method.

In another variation, the input variable data also includes constraints for the optimization. The optimization constraints are preferably based upon at least one business objective, such as maximizing revenue, maximizing security, minimizing enforcement cost, maximizing enforcement rate, minimizing enforcement time, or maximizing the patrol area of each enforcement agent, or any other constraint. The selection of the constraints preferably alters the optimization algorithm, for example, by changing the weights and/or the types of input variables used in the optimization algorithm. The constraints may change due to time of day, special scheduled events (such as concerts, sporting events, daily lot routines, etc.), number of enforcement agents on duty, or any other factor that may affect the optimization constraints.

Step S120, which recites optimizing a parking enforcement route based on the input variable data, functions to calculate one or more optimized enforcement routes based on the input variables collected in step S210. The optimized enforcement route(s) are preferably calculated with one or more optimization algorithms, such as linear programming, convex optimization, dijkstra's algorithm or any other optimization algorithm. In one variation, the calculation may output multiple optimized enforcement routes based upon one or more constraints. The input variable data are preferably each weighted, and the set of weights of each input variable preferably corresponds to the optimization constraint.

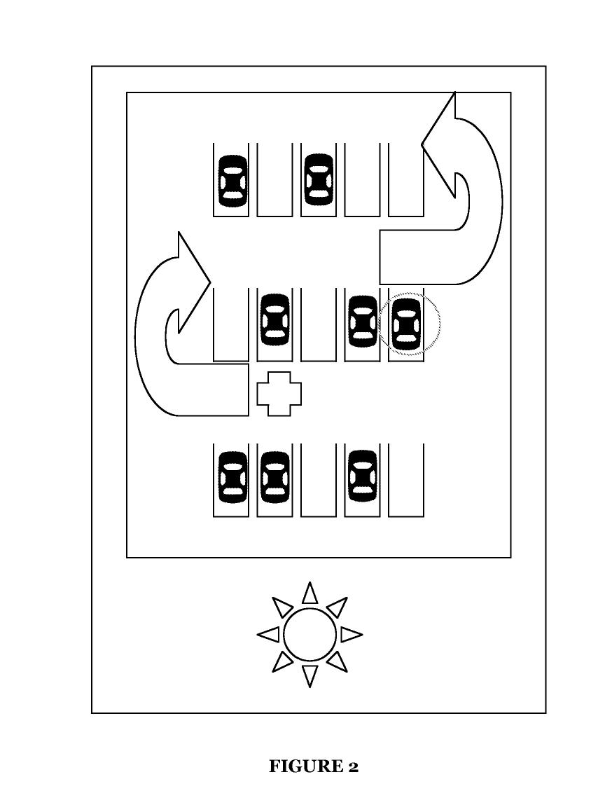

Step S130, which recites communicating the optimized parking enforcement route to an enforcement agent, functions to suggest at least one of the optimized route(s) to the enforcement agent. The enforcement agent preferably follows the received communication to optimally enforce parking in the monitored area. The enforcement agent may expeditiously ticket, boot, tow or in some other manner seek remedy or compensation from the unauthorized occupancy or use of a parking space. The communication is preferably performed by a visual interface, more preferably an electronic mapping interface. An example of an electronic mapping interface displaying the optimized route for a parking enforcement agent is shown in FIG. 2. The cross indicates the current location of the enforcement agent, and a parking violator is circled along the route. However, there are many alternative methods of communicating the optimized route(s), including an interactive GPS mapping system, audio directions, video directions, directions from external signs placed in the parking area, or text messages or emails sent to a mobile device, smartphone or cell phone, or any other method of communication with a parking enforcement agent.

As shown in FIG. 1, the preferred method 150 of the invention also includes updating the input variables S135. Step S135 functions to update the input variables, such that an updated optimized enforcement route may be calculated based upon the updated input variables and communicated to the enforcement agent. Preferably the input variable update occurs when there are new enforcement notifications, but may alternatively occur when the enforcement agent makes a decision to manually change the route (i.e. drives off the optimized route), or requests an updated optimized route, or requests a different optimization constraint. In another variation, the route(s) may be re-optimized using the updated input variable data at a fixed period of time (hourly, daily, monthly, annually, etc.). Less frequent updates of the input variables may be preferable if a parking area is predictable or rarely visited (i.e. long-term airport parking). In yet another variation, any number of the input variables may be static, and are never updated. The optimized route communication is preferably updated in real-time, immediately after the optimization algorithm is re-calculated with enforcement notifications and/or other input variable data that is received and/or updated.

In another alternative variation, if Step S135 is not executed (as in the case where there are no violations or input variable updates at a given time), the route communicated to the enforcement agent in Step S130 is preferably optimized so the enforcement agent has a high likelihood of proximity to the next projected violators, or most costly violators (such as a fire hydrant or handicapped parking space), depending on the constraints of the optimization.

In another alternative variation, feedback from the enforcement agent may be collected in Step S135. This feedback may include the marking of the completion of an enforcement task, or the registering of an error reading of one of the input variables, such as a parking sensor component or a malfunctioning identification reader. This feedback may result in the re-calibration of the sensing system or may alternatively be used to teach the optimization algorithm.

As a person skilled in the art of vehicle parking management will recognize from the previous detailed description and from the figures and claims, modifications and changes can be made to the preferred embodiments of the invention without departing from the scope of this invention defined in the following claims.

I claim:

1. A method for optimizing routes for vehicle parking enforcement comprising:
a) collecting input variable data;
b) optimizing a parking enforcement route based on the input variable data; and
c) communicating the optimized parking enforcement route to an enforcement agent.

2. The method of claim 1, wherein the input variable data includes one selected from the group consisting of enforcement notifications, clusters of parking violators, severity of a violation, price magnitude of a violation, proximity of enforcement agent to parking violator, time to reach parking violator, time to generate a citation, a parking grace period allowed by the lot, and number of enforcement agents.

3. The method of claim 1, wherein the input variable data includes one selected from the group consisting of: year, season, month, week, day of the week, time of day, parking lot scheduling, and special event parking.

4. The method of claim 1, wherein the input variable data includes predicted violations, wherein the predicted violations are calculated from historical data.

5. The method of claim 4, wherein the historical data includes one selected from the group consisting of parking space historical data and parking space occupant historical data.

6. The method of claim 1, wherein the input variable data includes an optimization constraint.

7. The method of claim 6, wherein the optimization constraint is selected from the group consisting of maximizing revenue, minimizing enforcement cost, maximizing enforcement rate, minimizing enforcement time, and maximizing the patrol area of each enforcement agent.

8. The method of claim 6, wherein the input variable data are each weighted, and wherein a set of weights of each input variable corresponds to the optimization constraint.

9. The method of claim 1, wherein the step of optimizing a parking enforcement route based on the input variable data includes one optimization algorithm selected from the group consisting of linear programming, convex optimization, and dijkstra's algorithm.

10. The method of claim 6, wherein the optimization of a parking enforcement route includes outputting a first optimized enforcement route and a second optimized enforcement route.

11. The method of claim 10, wherein the first optimized route and the second optimized route are optimized for different optimization constraints.

12. The method of claim 1, wherein the step of communicating the optimized parking enforcement route to an enforcement agent includes providing enforcement route directions to the enforcement agent.

13. The method of claim 12, wherein the enforcement route directions are presented to the enforcement agent visually.

14. The method of claim 13, wherein the enforcement route directions are presented to the enforcement agent on a map.

15. The method of claim 12, wherein the enforcement route directions are presented to the enforcement agent via audio.

16. The method of claim 12, wherein the enforcement route directions are presented to the enforcement agent via email or text messages sent to a mobile device.

17. The method of claim 1, further comprising the step of repeating steps a), b) and c) to generate a new optimized enforcement route.

18. The method of claim 17, wherein the new enforcement route is updated based upon updated enforcement notifications.

19. The method of claim 17, wherein the new enforcement route is updated at a fixed time interval.

20. The method of claim 17, wherein the new enforcement route is updated upon request of the enforcement agent.

21. The method of claim 17, wherein the new enforcement route is updated based upon predicted violations or cost of violations.

22. The method of claim 1, further comprising the step of collecting feedback from an enforcement agent.
